(19) United States
(12) Patent Application Publication
(10) Pub. No.: US 2011/0063075 A1
(43) Pub. Date: Mar. 17, 2011

(54) Control System for a Door Drive

(75) Inventor: Michael Hörmann, Halle/Westf. (DE)

(73) Assignee: Marantec Antriebs- und Steuerungstecknik GmbH & Co. KG, Marienfeld (DE)

(21) Appl. No.: 12/622,615

(22) Filed: Nov. 20, 2009

(30) Foreign Application Priority Data
Nov. 21, 2008 (DE) 102008058401.0

(51) Int. Cl. G05B 19/00; H02P 7/00

(52) U.S. Cl. 340/5.7; 318/452

(57) ABSTRACT

The present invention relates to a control system for a door drive with a plurality of components and a digital data bus via which the components communicate, wherein at least one safety component such as a closing edge-safety device or a light barrier detects safety-relevant events and reports the same via the data bus. When detecting a safety-relevant event, the safety component blocks the communication via the data bus for a certain time, wherein the remaining components detect the missing communication on the data bus and interpret the same as notification of a safety-relevant event.

### BACKGROUND OF THE INVENTION

The present invention relates to a control system for a door drive with a plurality of components and a digital data bus via which the components communicate, wherein at least one safety component such as a closing-edge safety device or a light barrier detects safety-relevant events and reports the same via the data bus. As digital data bus, one of the commercially available bus systems RS485, Profi-Bus, Ethernet, etc. can for instance be used.

Such system is known for instance from DE 20 2005 021 457 U1. The data to be transmitted, by means of which the safety component reports a safety-relevant event, are packed into a telegram and sent via the data bus. Since the communication on the data bus is controlled by a master component, transmission will however only be effected when the master component addresses the safety component the next time. How fast a telegram is transmitted therefore depends both on the transmission rate and on the number of bus users. Safety-relevant devices such as the closing-edge safety device or closed circuits should, however, be able to report a safety-relevant event as quickly as possible and without delay.

### SUMMARY OF THE INVENTION

Therefore, it is the object of the present invention to provide a control system for a door drive, which has a rather short or at least calculable transmission time for safety-relevant devices.

This object is solved by a control system according to the description herein and the corresponding methods for controlling door drives. Advantageous aspects of the invention are also subject-matter herein.

The present invention comprises a control system for a door drive with a plurality of components and a digital data bus via which the components communicate. There is provided a safety component such as a closing-edge safety device or a light barrier, which detects safety-relevant events and reports the same via the data bus. In accordance with the invention, the safety component blocks the communication on the data bus for a certain time when it detects a safety-relevant event. The remaining components can detect the missing communication on the bus system and interpret the same as notification of a safety-relevant event. Thus, the remaining components can correspondingly react to the safety-relevant event. Safety-relevant events, which are detected and reported by the safety component, include in particular events lying outside the control system, which are relevant for the safety of the door drive, such as the impact of the door edge onto an obstacle.

The safety component hence triggers a safety interrupt, when it detects a safety-relevant event, by blocking the communication on the data bus for a certain time. The great advantage of such notification of safety-relevant events is that such safety interrupt can be triggered at any time. The reaction time is independent of the transmission rate and independent of the number of bus users.

Advantageously, it is provided that the motor of the door drive is stopped and/or returned upon notification of a safety-relevant event. Hence, when the safety component blocks the communication on the data bus, the control of the door drive recognizes the same as a safety-relevant event and immediately stops and returns the motor.

The present invention is particularly advantageous in a control system in which the communication via the data bus is controlled by a master component which individually addresses each of the slave components. The safety component can be a slave component. Hence, the digital bus system of the invention is e.g. a bus system with fixed communication windows. The master component always addresses only one slave component and the same thereupon sends back an answer. In the next communication window, the master component addresses the next slave component. The master component can choose any sequence of addressed slave components.

If in such system a safety-relevant event is transmitted via a data telegram like in the prior art, it is not ensured at any time that the safety-relevant event is reported as quickly as possible. Rather, this event would only be reported when the master component addresses the safety-relevant slave component the next time. A safety interrupt of all components with a disturbed or missing communication on the data bus already is provided in the prior art, in order to avoid dangers caused by a door drive running on in the case of an internal malfunction e.g. of the master component. However, the present invention now provides that the safety component actively triggers such safety interrupt when it detects a safety-relevant, in particular external event. Active triggering of the safety interrupt provides for an immediate reaction, since it is not dependent on the exchange of data controlled by the master component.

Triggering of a safety interrupt by the safety component in accordance with the invention hence allows the same to report a safety-relevant event at any time. For this purpose, the safety component blocks the communication on the digital data bus for a defined period. All other bus users detect the missing communication and interpret the same as a safety-relevant event. The door drive reacts to this information by quickly stopping the motor. What kind of safety-relevant event this is initially is of secondary importance for the fast reaction of the door drive control, so that the notification of detailed information by a data telegram, as is provided in the prior art for reporting a safety-relevant event, is omitted in favor of a faster notification in the first step.

Advantageously, however, it is provided that in a second step, when the communication on the data bus is enabled again, the master component asks the slave components which safety-relevant event has been detected. The master component then can possibly output corresponding control commands. When the data bus thus is enabled again by the safety component, the master can ask the slave components what event this is. In a second step, upon notification of the occurrence of a safety-relevant event by the safety interrupt of the invention, the detailed information on the safety-relevant event thus can be reported by the standard transmission of a corresponding data telegram.

Alternatively, however, it can also be provided that the communication via the data bus is controlled by a master component which individually addresses each of the slave components, wherein the safety-component is the master component. The safety component hence controls the communication on the data bus. For reporting a safety-relevant event it now blocks the communication by not transmitting anymore. As a result, all connected slave components at the same time detect that there is a safety-relevant event, without the safety component having to address all slave components individually. Upon restarting the communication, the safety component then can address individual slave components in a second step and thus specifically react to the safety-relevant event.

The present invention comprises an alternative control system for a door drive with a plurality of components and a digital data bus via which the components communicate. There is in turn provided at least one safety component such as a closing-edge safety device or a light barrier, which detects safety-relevant events and reports the same via the data bus. In accordance with the invention, the communication is controlled via the bus system by means of an arbitration. In accordance with the invention, the safety component transmits the notification of a safety relevant event by using a system-specific address, in particular the address with the highest priority. Usually, this is the lowest address.

In bus systems with arbitration, the communication is not organized by a master component, but all bus users can attempt to transmit a data telegram at any time. When several users want to transmit a telegram at the same time, the telegram with the lower address is successful, which is referred to as arbitration. A bus user who has lost the arbitration will change from “transmit” to “receive”. He will restart transmitting his telegram when the bus is free again.

In accordance with the invention, safety-relevant events now always are transmitted with a system-specific address, in particular the address with the highest priority. This ensures that this information is transmitted at any time in the next telegram. Hence, telegrams with safety-relevant events always have the highest priority during transmission via the digital bus system.

The present invention furthermore comprises methods for controlling a door drive, as they are implemented in the control systems of the invention. Implementing the method of the invention is effected by a corresponding configuration or programming of the control electronics and the bus system. The components of the control system each comprise a corresponding control electronics, which usually is configured on the basis of one or more microcontrollers or microcomputers.

The invention in particular comprises a method for controlling a door drive, in which a plurality of components communicate via a digital data bus, wherein at least one safety component, such as a closing-edge safety device or a light barrier, detects safety-relevant events and reports the same via the data bus. It is provided that when detecting a safety-relevant event, the safety component blocks the communication on the data bus for a certain time, wherein the remaining components detect the missing communication on the bus system and interpret the same as notification of a safety-relevant event. This provides the same advantages as already set forth above with respect to the control system of the invention.

Advantageously, it is furthermore provided that the motor of the door drive is stopped and/or returned upon notification of a safety-relevant event.

In accordance with the invention, the communication via the data bus advantageously is controlled by a master component which individually addresses each of the slave components. With this communication architecture, the method of the invention nevertheless allows an immediate reaction to the detection of safety-relevant events.

In accordance with the invention, the communication via the data bus advantageously is controlled by a master component which individually addresses each of the slave components, wherein the safety component is a slave component. With this communication architecture, the method of the invention nevertheless allows an immediate reaction to the detection of safety-relevant events, wherein the reaction time is independent of the transmission rate and the number of bus users.

After the immediate notification of a safety-relevant event by the safety interrupt, it is interesting for the master only in the second step which concrete event has occurred. Advantageously, it now is provided that, when the communication via the data bus is enabled again, the master component asks the slave components which safety-relevant event has been detected. The master component will then possibly send corresponding control commands as a reaction to the information as to which safety-relevant event has occurred.

Alternatively, it can however also be provided that the communication via the data bus is controlled by a master component which individually addresses each of the slave components, wherein the safety component is the master component.

The present invention comprises a further method for controlling a door drive, in which a plurality of components communicate via a digital data bus, wherein at least one safety component, such as a closing-edge safety device or a light barrier, detects safety-relevant events and reports the same via the data bus. It is provided that the communication via the bus system is controlled by means of an arbitration and, when detecting a safety-relevant event, the safety component transmits the notification of the event by using a system-specific address, in particular the address with the highest priority. Reporting safety-relevant events under the highest priority likewise ensures that this information can be transmitted at any time in the next telegram.

The present invention furthermore comprises a door drive with a control system, as described above. The door drive can be employed for driving any doors, e.g. for opening and closing garage doors or factory doors. The doors can be e.g. tilting, roll-up or swing-out doors. A door drive of the invention comprises a drive unit with a motor, by which the door can be opened and closed. A control electronics of the drive unit controls the movement of the drive unit and hence of the door and communicates with further components via a digital data bus.

Components conceivable include e.g. a hand-held transmitter, a programming unit, a wall-mounted switch or similar input and output components. Furthermore, at least one safety component such as a closing-edge safety device, a light barrier or a closed circuit is provided, which detects safety-relevant events.

By using the methods of the invention for reporting safety-relevant events by triggering a safety interrupt, the problems involved in a normal data transmission can be avoided. In particular, the present invention provides for a short and in particular calculable transmission time for safety-relevant devices.

### BRIEF DESCRIPTION OF THE DRAWINGS

The present invention will now be explained in detail with reference to an embodiment and the Figures, in which:

FIG. 1: shows the normal communication on the data bus of an embodiment of a control system in accordance with the invention,

FIG. 2: shows the notification of a safety-relevant event by blocking the communication on the data bus, and

FIG. 3: shows the procedure upon notification of a safety-relevant event, when the communication on the data bus is enabled again.

### DESCRIPTION OF THE PREFERRED EMBODIMENTS

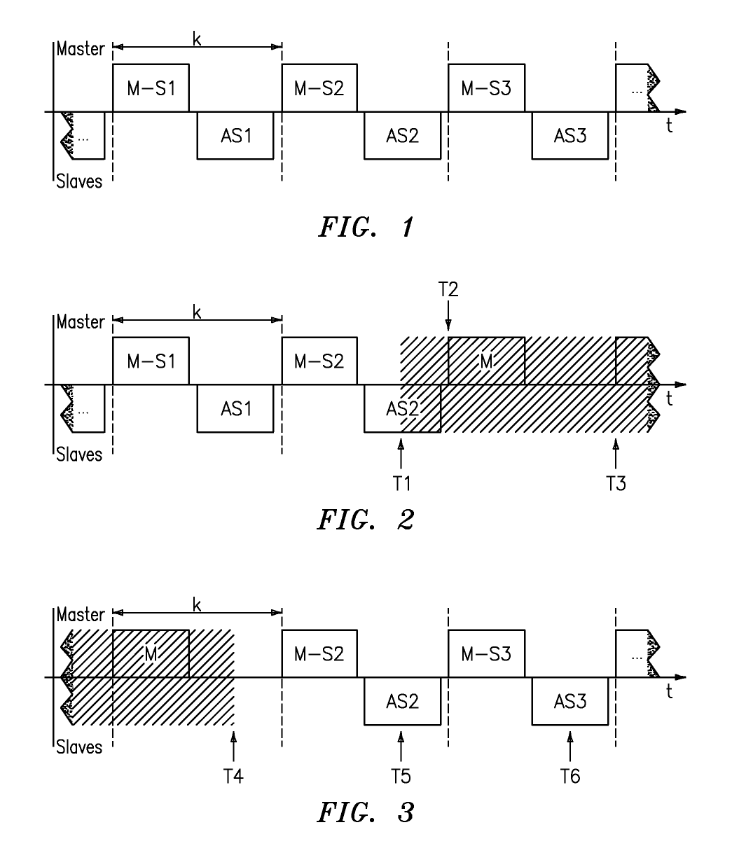

FIGS. 1 to 3 show the mode of operation of an embodiment of a control system of the invention, in which an embodiment of a method of the invention for controlling a door drive is implemented. The embodiment is a control system for a door drive with a plurality of components and a digital data bus via which the components communicate with each other, wherein at least one safety component such as a closing-edge safety device or a light barrier is provided, which detects safety-relevant events and reports the same via the data bus.

There is provided a master component M which controls the communication via the data bus. The same individually addresses each of the slave components S1-S3, for which purpose fixed communication windows K are provided. At least the slave component S3 is a safety component, wherein the other slave components and/or the master component also can be safety components. There can also be provided further slave components not shown in the embodiment.

FIGS. 1 to 3 each illustrate the communication via the data bus. FIG. 1 shows the normal communication via the digital data bus. There are provided fixed communication windows K, in which the master component M interrogates the individual slave components S1-S3 one after the other. In the data telegram M-S1, the master component M transmits to the slave component S1. Thereupon, the slave component S1 responds in the succeeding data telegram AS1. In this way, a telecommunication window K is closed. In the data telegram M-S2, the master component M thereupon transmits to the slave component S2. The same responds in the data telegram AS2 to the master. In the next communication window, the master component M correspondingly transmits to the slave component S3 by sending the data telegram M-S3. The same in turn responds through the telegram AS3. Upon completion of the communication cycle, the master component in turn starts to transmit to the slave component S1. A different number of slave components can of course also be used, in particular more than three slave components. The master component can address the slave components either in a pre-defined order or can each determine this order itself.

FIG. 2 now shows the communication on the data bus when a safety-relevant event is detected. In the first communication window, the master still quite normally transmits in the data telegram M-S1 to the slave component 1, which responds by AS1. In the second communication window, the master component transmits in the data telegram M-S2 to the slave component 2, which thereupon wants to respond by AS2. At the time T1, however, the safety component S3 now detects a safety-relevant event. As a response, the safety component S3 thereupon blocks the bus, so that no more communication is possible via the data bus. The blocked period is shown in hatched lines. At the time T2, the master component M in turn tries to send a data telegram. Blockage of the data bus however prevents the master component from sending the data telegram, so that the master component detects the blockage of the data bus already at the time T2 and interprets this as notification of a safety-relevant event. At the time T3, all slave components detect the blockage of the data bus, because no communication has occurred within the past communication window. The slave components interpret this blockage of the communication as notification of a safety-relevant event and react correspondingly. In particular, the motor control stops the motor of the door drive.

In FIG. 3, the communication via the data bus now is illustrated after the notification of a safety-relevant event has occurred. At the time T4, the safety component removes the blockage of the bus. The period between the blockage of the data bus at the time T1 and the release of the data bus at the time T4 is chosen such that at least for one communication window the communication on the data bus is blocked, so that all slaves can detect the blockage. For instance, the blockage can last for two or more communication windows. Upon removal of the blockage at the time T4, the master component M resumes the communication with the individual slave components at the beginning of the following communication window. With the data telegram M-S2, the master initially transmits to the slave S2 which responds to the master by the data telegram AS2. The master asks whether the slave component S2 has been notified of a safety-relevant event. However, the slave component S2 informs the master that there is no safety-relevant event. In the next communication window, the master component then transmits to the slave component S3 with the data telegram M-S3 and asks whether a safety-relevant event has occurred. The slave component S3, i.e. the safety component, now informs the master that a safety-relevant event has been detected and what kind of safety-relevant event this is. In the succeeding communication windows, the master component then can send corresponding control commands to the individual slave components.

In accordance with the invention, there can also be provided a plurality of safety components which each block the communication on the data bus for a certain time, when they detect a safety-relevant event. For instance, both the slave components S2 and S3 might each represent safety components.

The method of the invention thus ensures that all slave components detect the notification of a safety-relevant event at the same time, when the communication on the data bus has been blocked for a communication window. Hence, the reaction time only amounts to between one and two communication windows independent of the number of users and the capacity of the bus system. Since for the reaction to a safety-relevant event it initially is not necessary to obtain detailed information on the kind of the safety-relevant event, it is sufficient that the master component will not ask with which slave component the safety-relevant event has occurred and what kind of safety-relevant event this was, before blockage of the data bus is removed.

1. A control system for a door drive with a plurality of components and a digital data bus via which the components communicate, wherein at least one safety component such as a closing-edge safety device or a light barrier detects safety-relevant events and reports the same via the data bus,
when detecting a safety-relevant event, the safety component blocks the communication on the data bus for a certain time, and the remaining components detect the missing communication on the bus system and interpret the same as notification of a safety-relevant event.

2. The control system according to claim 1, wherein the motor of the door drive is stopped and/or returned upon notification of a safety-relevant event.

3. The control system according to claim 1, wherein the communication via the data bus is controlled by a master component which individually addresses each of the slave components, and the safety component is a slave component.

4. The control system according to claim 3, wherein, when the communication on the data bus is enabled again, the master component asks the slave components which safety-relevant event has been detected and possibly outputs corresponding control commands.

5. The control system according to claim 1, wherein the communication via the data bus is controlled by a master component which individually addresses each of the slave components, and the safety component is the master component.

6. The control system for a door drive with a plurality of components and a digital data bus via which the components communicate, wherein at least one safety component such as a closing-edge safety device or a light barrier detects safety-relevant events and reports the same via the data bus,
the communication via the bus system is controlled by an arbitration and, when detecting a safety-relevant event, the safety component transmits the notification of the event by using a system-specific address.

7. A door drive with a control system according to claim 6.

8. A method for controlling a door drive, in which a plurality of components communicate via a digital data bus, wherein at least one safety component such as a closing-edge safety device or a light barrier detects safety-relevant events and reports the same via the data bus,
when detecting a safety-relevant event, the safety component blocks the communication on the data bus for a certain time, and the remaining components detect the missing communication on the bus system and interpret the same as notification of a safety-relevant event.

9. The method according to claim 8, wherein the motor of the door drive is stopped and/or returned upon notification of a safety-relevant event.

10. The method according to claim 8, wherein the communication via the data bus is controlled by a master component which individually addresses each of the slave components, wherein the safety component is a slave component.

11. The method according to claim 10, wherein the master component, when the communication on the data bus is enabled again, asks the slave components which safety-relevant event has been detected and possibly outputs corresponding control commands.

12. The method according to claim 8, wherein the communication via the data bus is controlled by a master component, which individually addresses each of the slave components, wherein the safety component is the master component.

13. The method for controlling a door drive, in which a plurality of components communicate via a digital data bus, wherein at least one safety component such as a closing-edge safety device or a light barrier detects safety-relevant events and reports the same via the data bus, the communication via the bus system is controlled by an arbitration and, when detecting a safety-relevant event, the safety component transmits the notification of the event by using a system-specific address.

14. A door drive with a control system according to claim 1.

15. The control system according to claim 2, wherein the communication via the data bus is controlled by a master component which individually addresses each of the slave components, and the safety component is a slave component.

16. The control system according to claim 15, wherein, when the communication on the data bus is enabled again, the master component asks the slave components which safety-relevant event has been detected and possibly outputs corresponding control commands.

17. The control system according to claim 2, wherein the communication via the data bus is controlled by a master component which individually addresses each of the slave components, and the safety component is the master component.

18. The method according to claim 9, wherein the communication via the data bus is controlled by a master component which individually addresses each of the slave components, wherein the safety component is a slave component.

19. The method according to claim 18, wherein the master component, when the communication on the data bus is enabled again, asks the slave components which safety-relevant event has been detected and possibly outputs corresponding control commands.

20. The method according to claim 9, wherein the communication via the data bus is controlled by a master component, which individually addresses each of the slave components, wherein the safety component is the master component.
